(19) United States
(12) Patent Application Publication
(10) Pub. No.: US 2020/0353300 A1
(43) Pub. Date: Nov. 12, 2020

(54) INJECTION HEAD HAVING SILENCING FUNCTION FOR GAS-TYPE FIRE EXTINGUISHER AND METHOD FOR STORING AND ASSEMBLING THEREOF

(71) Applicant: KOATSU CO., LTD., Itami-shi, Hyogo (JP)

(72) Inventors: Yasufumi INOUE, Hyogo (JP); Masahiro YABUSHITA, Hyogo (JP)

(73) Assignee: Koatsu Co., Ltd., Itami-shi, Hyogo (JP)

(21) Appl. No.: 16/095,513

(22) PCT Filed: Dec. 15, 2017
(86) PCT No.: PCT/JP2017/045110

§ 371 Date: Oct. 22, 2018

(30) Foreign Application Priority Data
Dec. 26, 2016 (JP) 2016-251814

(51) Int. Cl. A62C 31/02; B05B 1/00

(52) U.S. Cl. CPC A62C 31/02; B05B 1/005; B05B 1/002

(57) ABSTRACT

By making it to provide an injection head having silencing function for gas-type fire extinguisher and method for storing and assembling thereof capable of eliminating the problems of limitations of place of storage and the cost increase, by making it easy to storage the injection head as stock, the injection head is comprising an injection head main body forming a connecting part for connecting a pipe, an orifice plate forming orifice disposed in the injection head main body for passing the fire extinguishing gas, and a silencing member of block shapes formed on porous material capable of passing the fire extinguishing gas disposed at the outlet side of the orifice plate for releasing the fire extinguishing gas, wherein the orifice plate is disposed detachably in the injection head main body through an opening in the side of a connecting part connected to a piping of the injection head main body.

### TECHNICAL FIELD

The present invention relates to a gas-type fire extinguisher using a fire-extinguishing gas such as nitrogen, carbon dioxide, or fluorine compound, and more particularly to an injection head installed on a ceiling or wall for releasing fire-extinguishing gas to a fire-extinguishing area, and specifically to an injection head having a silencing function for gas-type fire extinguisher capable of reducing noise generated at the time of emission of fire-extinguishing gas.

### BACKGROUND ART

In a gas-type fire extinguisher using a fire-extinguishing gas such as nitrogen, carbon dioxide, or fluorine compound, when the gas-type fire extinguisher operates for extinguishing a fire, the fire-extinguishing gas is released so that the fire-extinguishing gas concentration in the fire-extinguishing area may reach a fire-extinguishing concentration within about a minute (about 10 seconds in the case of fire-extinguishing gas of fluorine compound).

At this time, the fire-extinguishing gas is released from an injection head installed in a ceiling or a wall for releasing fire-extinguishing gas to the fire-extinguishing area, but the injection head for a gas-type fire extinguisher includes, as shown in FIG. 24(a), an orifice 20 at an outlet of an injection head 10A connected to a piping 40 for supplying a fire-extinguishing gas, for releasing the fire-extinguishing gas directly to the fire-extinguishing area from the orifice 20, or includes, as shown in FIG. 24(b), an orifice 20 and a conical deflector (deflecting member) 50 at an outlet of an injection head 10B connected to a piping 40 for supplying a fire-extinguishing gas, for releasing the fire-extinguishing gas released from the orifice 20 to the fire-extinguishing area by deflecting by the deflector (deflecting member) 50, or further includes, as shown in FIG. 24(c), an orifice (not shown) and a conical tubular horn (dispersion member) 60 at an outlet of an injection head 10C, for releasing the fire-extinguishing gas to the fire-extinguishing area by diffusing by the horn (diffusion member) 60, which have been used conventionally.

Thus, the conventional gas-type fire extinguisher injection heads 10A, 10B, and 10C are designed to release a same amount of fire-extinguishing gas from individual injection heads usually installed in a plurality in the fire-extinguishing area, and therefore the flow rate of fire-extinguishing gas released from the injection heads is limited by the orifice 20, and hence at the time of emission of fire-extinguishing gas from the injection heads, it is known that high level noise (specifically noise of over about 120 dB) is generated.

At the time of operation of the gas-type fire extinguisher, it is supposed no one exits in the fire-extinguishing area, conventionally, no problem has been considered about the noise (vibration) generated at the time of emission of fire-extinguishing gas from the injection heads, and no countermeasures have been taken.

Recently, however, in consideration of the case someone is left over in the fire-extinguishing area at the time of operation of the gas-type fire extinguisher, or adverse effects on the surrounding people of the noise source at the time of emission of fire-extinguishing gas from the injection heads, and the noise (vibration) may cause troubles in the precision machines such as information communication devices, it has been proposed technologies to reduce the noise generated at the time of emission of the fire-extinguishing gas (see, for example, patent literature 1 to 5).

### PRIOR ART DOCUMENTS

### Patent Literature

[Patent Literature 1] Japan Patent Publication Tokuhyo (Japan Unexamined Patent Publication) 2011-115255.

[Patent Literature 2] Japan Patent Publication Tokuhyo (Japan Unexamined Patent Publication) 2011-125673.

[Patent Literature 3] Japan Patent Publication Tokuhyo (Japan Unexamined Patent Publication) 2011-255152.

[Patent Literature 4] Japan Patent Publication Tokuhyo (Japan Unexamined Patent Publication) 2013-169333.

[Patent Literature 5] Japan Patent Publication Tokuhyo (Japan Unexamined Patent Publication) 2013-192764.

### SUMMARY OF INVENTION

### Problems to be Solved by the Invention

Therefore, in order to solve the problems caused by noise (including vibration) (hereinafter simply called noise) generated at the time of emission of fire-extinguishing gas from the injection heads, among the above technologies, the technology disclosed in patent literature 1 is intended to interlock the starting timing of the fire extinguisher with the avoid remedy timing for preventing malfunction of the ICT device due to starting of the fire extinguisher in case when the fire extinguisher should be started, and it is not intended to lower the noise level.

On the other hand, the technologies disclosed in patent literature 2 to 5 are intended to lower the noise level, but for increasing a decreasing rate of the noise, the injection head becomes large size comparing to a general injection head, and there are problems in the aspects of limitations of place of storage and place of installation and the cost increase.

Especially, the gas-type fire extinguisher needs to release fire extinguishing gas within the regulated time according to area volume for releasing fire extinguishing gas, and hence, the flow rate of the fire extinguishing gas released from each injection head needs to be different according the area volume, and the number of injection heads releasing the fire extinguishing gas.

The control of the flow rate of this fire extinguishing gas is conducted, usually, by selecting the shape of the orifice provided in the injection head (size and quantity of the orifices formed in the orifice plate for passing the fire extinguishing gas).

For this reason, even if one shape or one size is taken up, the injection head has several dozen types due to difference in shape of the orifices, and furthermore, has several hundred types by counting numbers for every size (20A, 25A, 32A, 40A).

Then, for allowing shipping of the injection head quickly, only in one shape of the injection head, several hundred types differing the shape of the orifices should be stored as stock, and hence there were problems in the aspects of limitations of place of storage and the cost increase.

The object of the present invention is to provide an injection head having silencing function for gas-type fire extinguisher and method for storing and assembling thereof capable of eliminating the problems of limitations of place of storage and the cost increase, by making it easy to storage the injection head as stock, considering problems of above-mentioned conventional injection heads for gas-type fire extinguisher, especially the injection heads having silencing function for gas-type fire extinguisher.

### Means for Solving the Problems

To achieve the object above, an injection head having a silencing function for gas-type fire extinguisher of the present invention, being an injection head having a silencing means installed by connecting a piping for providing a fire-extinguishing gas for releasing the fire-extinguishing gas in a fire-extinguishing area in the gas-type fire extinguisher using a fire-extinguishing gas, wherein said silencing means is composed of an injector head main body forming a connecting part connecting said piping, an orifice plate forming an orifice passing a fire extinguishing gas disposed in said injection head main body, and a silencing member of block shapes formed on porous material capable of passing a fire extinguishing gas disposed at the outlet side of the orifice plate for releasing a fire extinguishing gas, and wherein said orifice plate is disposed detachable in said injector head main body through an opening of said connecting part connected to said piping of said injector head main body.

In this case, it can be performed that said orifice plate is fixed by a C-type retaining ring mounted on said connecting part side connected with said piping of said injection head main body, and said orifice plate is screwed into said said injection head main body, and said orifice plate is forming an operation part for rotating said orifice plate through an opening of said connecting part side connected to said piping of said injection head main body.

A method for storing and assembling an injection head having silencing function for gas-type fire extinguisher of the present invention, being a method for storing and assembling an injection head having a silencing means installed by connecting a piping for providing a fire-extinguishing gas for releasing the fire-extinguishing gas in a fire-extinguishing area in the gas-type fire extinguisher using a fire-extinguishing gas according above, wherein said injection head is composed of an injector head main body forming a connecting part connecting said piping, an orifice plate forming an orifice passing a fire extinguishing gas disposed in said injection head main body, and a silencing member of block shapes formed on porous material capable of passing a fire extinguishing gas disposed at the outlet side of the orifice plate for releasing a fire extinguishing gas, wherein said orifice plate is disposed detachable in said injector head main body through an opening of said connecting part connected to said piping of said injector head main body, and wherein said injection head is stored in a condition of which said silencing member assembled to said injection head main body, and when shipping, said orifice plate is attached to said injection head main body through said opening of said connecting part side of said piping of said injection head main body.

### Effects of Invention

According to the injection head having silencing function for gas-type fire extinguisher and method for storing and assembling thereof of the present invention, the orifice plate is detachably disposed in the injection head main body through the opening of the connecting part side connecting to the piping of the injection head main body, and is stored as stock in a condition of which the silencing member assembled to the injection head main body, when shipping, the orifice plate according to the flow rate of the fire extinguishing gas released from the injection head is attached to the injection head main body through the opening of the connecting part side of the piping of the injection head main body, and hence the injection head having silencing function for the gas-type fire extinguisher larger than a general injection head becomes easy to store as stock, and therefore while eliminating the problems of the limitation of place of storage and the cost increase, the shipping of the injection head can be performed quickly.

### BRIEF DESCRIPTION OF DRAWINGS

FIG. 1 is a perspective view as seen obliquely from bottom showing a first embodiment of an injection head having a silencing function for gas-type fire extinguisher of the present invention.

FIG. 2 is a front view of the same.

FIG. 3 is a left side view of the same.

FIG. 4 is a plan view of the same (a state before amounting an orifice plate 31).

FIG. 5 is a bottom view of the same.

FIG. 6(a) is an X-X sectional view of FIG. 4 (a state being mounted an orifice plate 31), FIG. 6(b) is a plan view of a C-type retaining ring for using to fix an orifice plate.

FIG. 7 is a sectional view of a second embodiment of an injection head having a silencing function for gas-type fire extinguisher of the present invention.

FIG. 8 is showing a third embodiment of an injection head having a silencing function for gas-type fire extinguisher of the present invention, and FIG. 8(a) is a sectional view, FIG. 8(b) is a perspective view of an operation tool used for a rotation operation of an orifice plate.

FIG. 9 is a sectional view of a fourth embodiment of an injection head having a silencing function for gas-type fire extinguisher of the present invention.

FIG. 10 is a sectional view of a fifth embodiment of an injection head having a silencing function for gas-type fire extinguisher of the present invention.

FIG. 11 is a sectional view of a sixth embodiment of an injection head having a silencing function for gas-type fire extinguisher of the present invention.

FIG. 12 is a sectional view of a seventh embodiment of an injection head having a silencing function for gas-type fire extinguisher of the present invention.

FIG. 13 is a perspective view as seen obliquely from bottom showing a eighth embodiment of an injection head having a silencing function for gas-type fire extinguisher of the present invention.

FIG. 14 is a front view of the same.

FIG. 15 is a back side view of the same.

FIG. 16 is a left side view of the same.

FIG. 17 is a right side view of the same.

FIG. 18 is a plan view of the same (a state before amounting an orifice plate 31).

FIG. 19 is a bottom view of the same.

FIG. 20 is an X-X sectional view of FIG. 18 (a state being mounted an orifice plate 31).

FIG. 21 is a sectional view of a ninth embodiment of an injection head having a silencing function for gas-type fire extinguisher of the present invention.

FIG. 22 is a sectional view of a tenth embodiment of an injection head having a silencing function for gas-type fire extinguisher of the present invention.

FIG. 23 is a sectional view of a eleventh embodiment of an injection head having a silencing function for gas-type fire extinguisher of the present invention.

FIG. 24 is an explanatory diagram of an injection head for a conventional gas-type fire extinguisher.

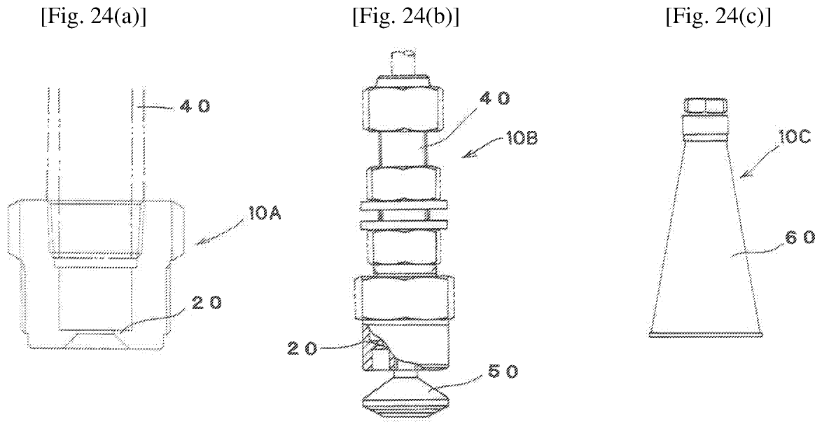

### BEST MODE FOR CARRYING OUT THE INVENTION

An embodiment of an injection head having a silencing function for a gas-type fire extinguisher of the present invention is described below by reference to the accompanying drawings.

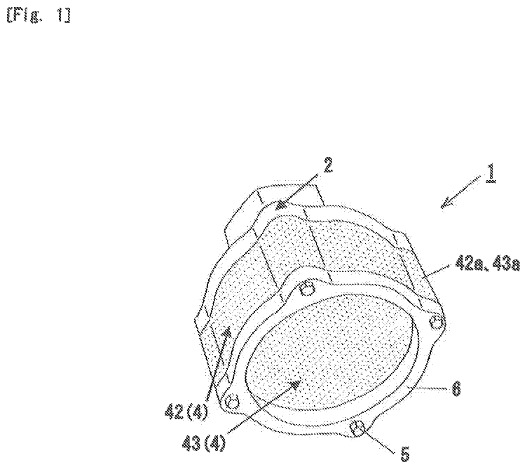

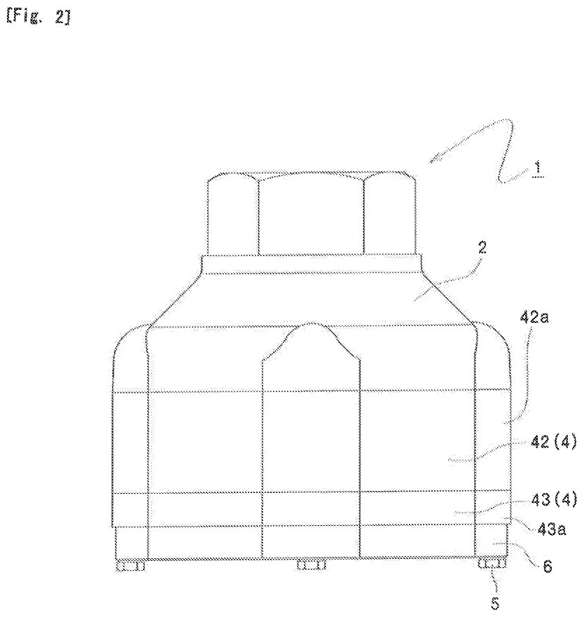

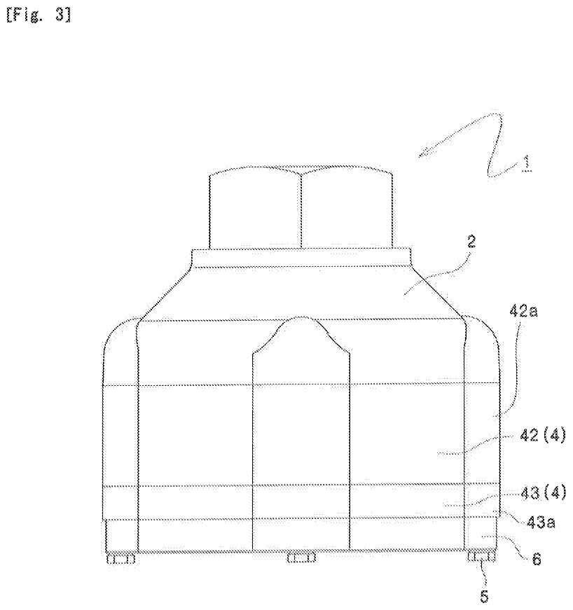

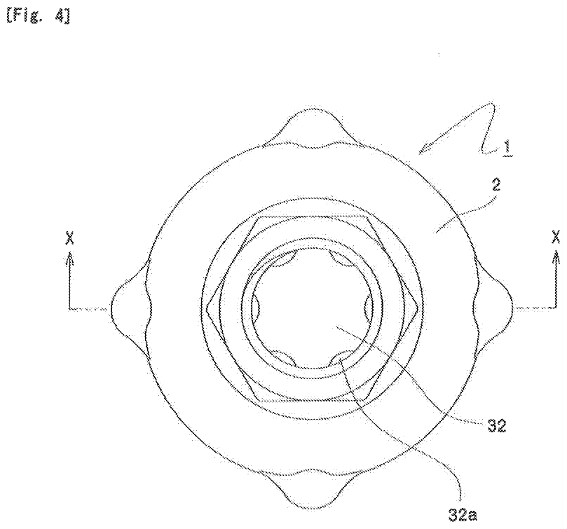

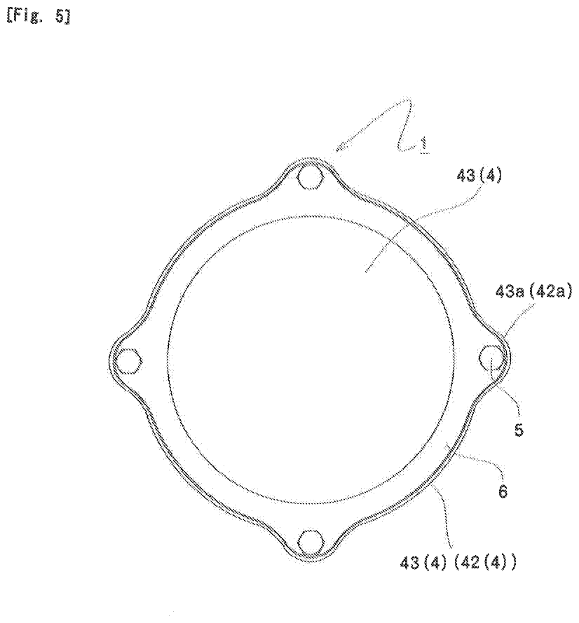

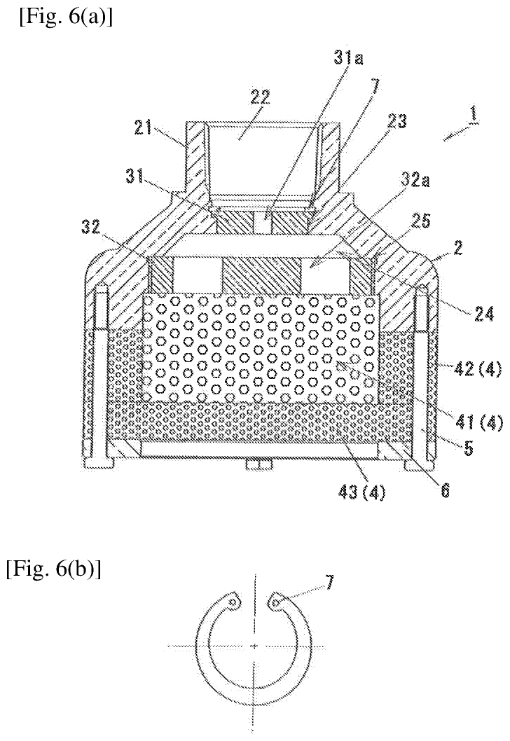

FIG. 1 to FIG. 6 show a first embodiment of an injection head having a silencing function for a gas-type fire extinguisher of the present invention.

This injection head 1 having silencing function for a gas-type fire extinguisher is, in a gas-type fire extinguisher using gas, connected to a piping (not showing) providing the fire extinguishing gas for releasing fire extinguishing gas into a fire-extinguishing area, and the injection head 1 is composing an injection head main body 2 forming a connecting part 21 connecting to the piping, an orifice plate 31, 32 forming an orifice 31a, 32a passing a fire extinguishing gas disposed in a injection head main body 2, and a silencing member 4 of block shapes formed on porous material capable of passing a fire extinguishing gas disposed at the outlet side of the orifice plate 31, 32.

In the present embodiment, the orifice plate 31, 32 is structured so that composing the orifice plate 31 detachably disposed in the injection head main body 2 through the opening in the side of the connecting part 21 of the injection head main body 2, and the orifice plate 32 disposed at the outlet side of the injection head main body 2 for releasing the fire extinguishing gas.

Then, a layer-like space 24 is formed between the orifice plate 31 and the orifice plate 32, and the silencing member 4 is disposed at the outlet side of the orifice plate 32 for releasing the fire extinguishing gas.

The orifice plate 31 has a function to restrict the flow rate of the fire extinguishing gas released from the injection head 1.

Then, for example, several types of the orifice plates 31 having different shapes of the orifices 31a (size and quantity of the orifice 31a) are prepared beforehand, then when shipping, the injection head main body 2 being stored as stock in a condition of which the silencing member 4 assembled to it, and the orifice plate 31 compatible with the flow amount of fire extinguishing gas released from the injection head according to the conditions of such as installation place for the injection head 1 are selected, and the orifice plate 31 selected is mounted on the injection head main body 2 through the opening 22 in the side of the connecting part 21 connecting with the piping of the injection head main body 2.

Here, the orifice plate 31 is disposed in a manner that it is placed down on a step 23 formed in an internal space in the side of the connecting part 21 of the injection head main body 2, and is fixed by a C-type retaining ring 7 mounted on in the connecting part 21 of the piping of the injection head main body 2. The fixing means of the orifice plate 31 is not limited to the C-type retaining ring 7, but an arbitrary system, such as a spring, a magnet, etc. other than a screw used in embodiments below, can be adopted. The orifice plate 31 is disposed in a manner that it is placed down on the step 23 formed in the internal space in the side the connecting part 21 of the injection head main body 2, and the orifice plate 31 is fixed by the pressure of the fire extinguishing gas when the fire extinguishing gas is releasing, and hence the fixing means may be omitted.

As a result, the injection head having silencing function for gas-type fire extinguisher larger than a general injection head becomes easy to store as stock, and shipping of the injection head 1 can be performed quickly while eliminating problems of the limitation of place of storage and the cost increase.

The orifice plate 32 forming a plurality of the orifices 32a is detachably disposed in a step 25 formed in an internal space of the injection head main body 2, for example, by way of screws formed in a peripheral surface of the step 25 and the orifice plate 32.

As a result, several types of the orifice plates 32 different in shapes of the orifices 32a (size and quantity of the orifice 32a) can be selected according to the conditions of the place of installation of the injection head 1, etc.

The orifice plate 32 detachable is omitted, and the same orifice 32a can be also formed directly in the injection head main body 2.

In this case, it is preferable that the orifice plate 32 is attached as being in contact by surface to the silencing member 4.

As a result, by distributing the fire-extinguishing gas uniformly from central parts of the silencing member 4 toward peripheral parts, the noise generated in the emission area of the fire-extinguishing gas can be made uniform, and the noise reduction rate can be further increased.

Other than the silencing member 4 of block shapes formed on a porous material comprising as an integral structure, the silencing member 4 can be comprising of, as shown in the embodiment, a central member 41, a peripheral member 42, and an end member 43 for covering the end faces of the central member 41 and the peripheral member 42 as split structures.

The porous material composing the silencing member 4 is preferably a metallic (Ni, N—Cr) porous body (“Celmet” (registered trademark) product of Sumitomo Electric Industries, Ltd) having continuous pores (porosity: maximum 98%) in which triangular skeletons are connected three-dimensionally by electroplating a foam resin subjected to conductive treatment, and then by heat treatment, other than a sinter material of inorganic material high in shape retaining performance (metal, oxide of metal, hydroxide of metal, etc.).

The pore diameter of pores of the porous material composing the silencing member 4 is made of a generally homogeneous material, or a material changed in the gas passing direction, or more particularly a material reduced in the gas passing direction, and for example, in this embodiment, it is made of a material becoming smaller in the pore diameter of the pores of the peripheral material 42 and the end face material 43, than the pore diameter of pores of the central material.

Thus, the pore diameter of pores of the porous material composing the silencing member 4 is made smaller in the gas passing direction, and by releasing the fire-extinguishing gas uniformly from the parts of the silencing member 4, so that the noise generated from the emission area of the fire-extinguishing gas can be made uniform, and the noise reduction rate can be further enhanced.

The silencing member 4 is fixed to the injection head main body 2 by the bolt 5 and the ring member 6.

The silencing member 4, whether in integral structure or in split structure, is disposed so that the one-end side of the silencing member 4 may contact with the injection head main body 2 (possibly including the orifice plate 32 in the present embodiment), and the peripheral parts and other-end side face of the silencing member 4 are opened to the atmosphere, except for the portion contacting with the ring members 6 for fixing the silencing member 4 to the injection head main body 2 by way of the bolts 5.

As a result, it is possible to increase the emission area of the fire-extinguishing gas to be released to the atmosphere of the silencing member 4, and moreover the injection reaction of fire-extinguishing gas applied to the injection head 1 at the time of emission of fire-extinguishing gas is canceled by the portion of the fire-extinguishing gas emitted from the surrounding of the silencing member 4 in the injection head 1, and can be decreased.

In this case, the bolt 5 penetrates through the silencing member 4, or in this embodiment, the inside of the peripheral member 42 and the end-face member 43, and is screwed into the injection head main body 2, and therefore the silencing member 4 is facing the orifice plate 32, and is fixed and integrated to the injection head main body 2.

As a result, it is possible to increase further the emission area of the fire-extinguishing gas to be released to the atmosphere of the silencing member 4, and the noise reduction rate can be enhanced, and generation of noise due to interference of the released fire-extinguishing gas with the bolt 5 can be prevented.

In the embodiment, the position of the silencing member 4 through which the bolt 5 penetrates, or in the present embodiment, positions 42a, 43a of the peripheral member 42 and end-face member 43 are formed in a shape swollen to the outer peripheral side from the other positions.

As a result, moreover, it is possible to increase the emission area of the fire-extinguishing gas to be released to the atmosphere of the silencing member 4, and the noise reduction rate can be enhanced.

Still more, when the porous material for composing the silencing member 4 is formed by cutting out from a plate material, waste of the material can be saved by forming into a shape of the present embodiment (a square-like shape).

In the present embodiment, the portion of the silencing member 4 through which the bolt 5 penetrates is formed in a shape swollen to the outer peripheral side than other positions, but can be formed in a uniform peripheral shape (cylindrical shape).

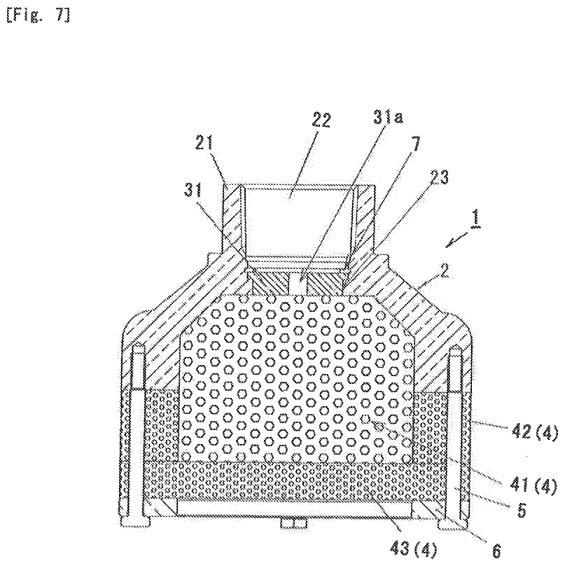

FIG. 7 shows a second embodiment of the injection head having the silencing function for gas-type fire extinguisher of the present invention.

In this injection head 1 having the silencing function for gas-type fire extinguisher, the orifice plate 32 of the injection head 1 of the first embodiment is omitted, and the silencing member 4 is disposed at the outlet side of the orifice plate 31 for releasing the fire-extinguishing gas (In other embodiments below, in the same way as the present embodiment, the orifice plate 32 can be omitted.).

In the injection head 1 of the first embodiment, at the outlet side of the orifice plate 31 for releasing the fire-extinguishing gas, a layer-like space 24 can be provided.

Other structure and action of the injection head 1 of the second embodiment are the same as in the injection head 1 of the first embodiment.

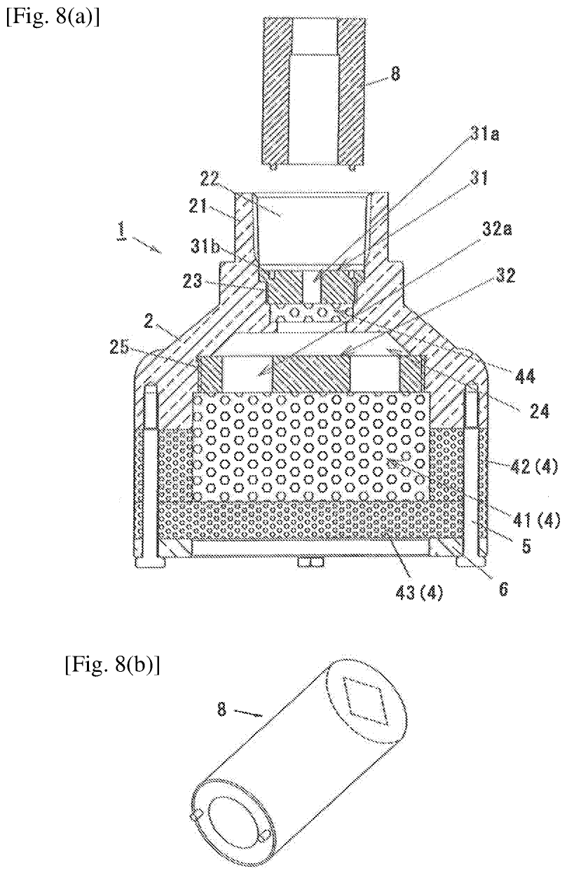

FIG. 8 shows a third embodiment of the injection head having the silencing function for gas-type fire extinguisher of the present invention.

In this injection head 1 having the silencing function for gas-type fire extinguisher, the orifice plate 31 of the injection head 1 of the first embodiment is fixed detachably by way of screws formed in the peripheral surface in the step 23 formed in the internal space in the side of the connecting part 21 of the injection head main body 2, and the orifice plate 32.

Here, the operation part 31b for rotating the orifice plate 31 is formed in the orifice plate 31 through the opening 22 in the side of the connecting part 21 connecting to the piping of the injection head main body 2, and the orifice plate 31 is detachable by using the operation tool 8 engaged with this operation part 31b for rotating the orifice plate 31.

At the outlet side of the orifice plate 31 for releasing the fire-extinguishing gas, the silencing member 44 is disposed.

Other structure and action of the injection head 1 of the third embodiment are the same as in the injection head 1 of the first embodiment.

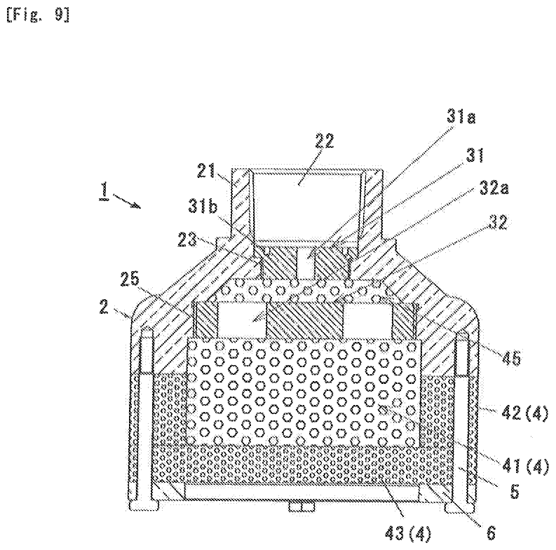

FIG. 9 shows a fourth embodiment of the injection head having the silencing function for gas-type fire extinguisher of the present invention.

In this injection head 1 having the silencing function for gas-type fire extinguisher, in the same way as the injection head 1 of the third embodiment, the orifice plate 31 of the injection head 1 of the first embodiment is fixed detachably by way of screws formed in the peripheral surface of the step 23 and the orifice plate 32 formed in the internal space in the side of the connecting part 21 of the injection head main body 2.

Also, the silencing member 45 is disposed at the place which was the space 24 in the injection head 1 of the first embodiment, and was continued from the outlet side of the orifice plate 31 for releasing the fire extinguishing gas.

Other structure and action of the injection head 1 of the second embodiment are the same as in the injection heads 1 of the first embodiment and the third embodiment.

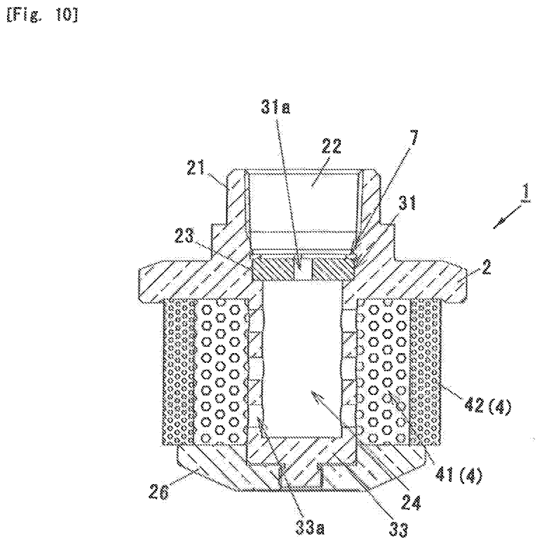

FIG. 10 shows a fifth embodiment of the injection head having the silencing function for gas-type fire extinguisher of the present invention.

In this injection head 1 having the silencing function for gas-type fire extinguisher, instead of the orifice plate 32 of the injection head 1 of the first embodiment, the orifice cylinder 33 with a bottomed cylindrical shape formed plurality of the orifices 33a in the peripheral surface is provided to extend from the injection head main body 2, the silencing member 4 of block shapes formed on porous material capable of passing the fire extinguishing gas is disposed at the outlet side of the orifice plate 33 for releasing the fire extinguishing gas, and the silencing member 4 is supported by deflector 26 screwing the bottom face of the silencing member 4 to the orifice cylinder 33.

The silencing member 4 is formed in split structures, composed of a central member 41, and a peripheral member 42.

The orifice cylinder 33 can be composed of another member, and integrated by a screw, etc. with the injection head 2, other than composed of an integral structure with the injection head 2.

Other structure and action of the injection head 1 of the fifth embodiment are the same as in the injection head 1 of the first embodiment.

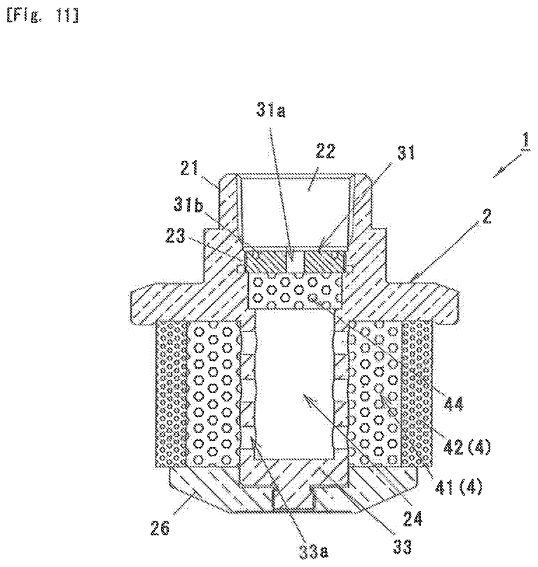

FIG. 11 shows a sixth embodiment of the injection head having the silencing function for gas-type fire extinguisher of the present invention.

In this injection head 1 having the silencing function for gas-type fire extinguisher, in the same way as the third embodiment, the orifice plate 31 of the injection head 1 of the fifth embodiment is fixed detachably by way of screws formed in the peripheral surface in the step 23 and the orifice plate 32 formed in the internal space in the side of the connecting part 21 of the injection head main body 2.

Here, at the outlet side of the orifice plate 31 for releasing the fire extinguishing gas, the silencing member 44 is disposed.

Other structure and action of the injection head 1 of the sixth embodiment are the same as in the injection heads 1 of the first embodiment, the third embodiment, and the fifth embodiment.

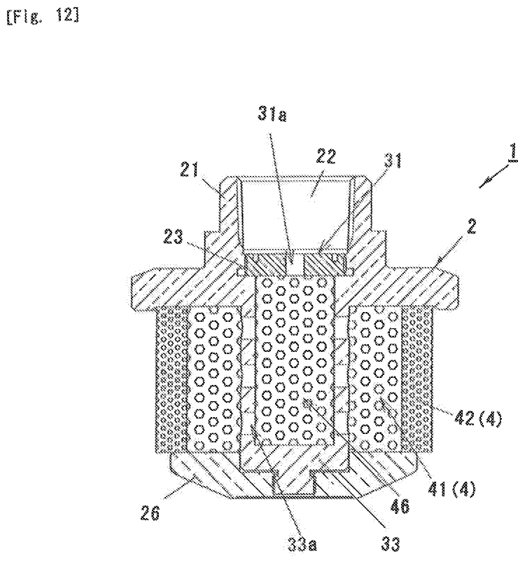

FIG. 12 shows a seventh embodiment of the injection head having the silencing function for gas-type fire extinguisher of the present invention.

In this injection head 1 having the silencing function for gas-type fire extinguisher, in the same way as the injection head 1 of the third embodiment, the orifice plate 31 of the injection head 1 of the fifth embodiment is fixed detachably by way of screws formed in the peripheral surface in the step 23 and the orifice plate 32 formed in the internal space in the side of the connecting part 21 of the injection head main body 2.

Also, the silencing member 46 is disposed at the place which was the space 24 in the orifice cylinder 33 with a bottomed cylindrical shape, and is continued to the outlet side of the orifice plate 31 for releasing the fire extinguishing gas.

Other structure and action of the injection head 1 of the seventh embodiment are the same as in the injection heads 1 of the first embodiment, the third embodiment, and the fifth embodiment.

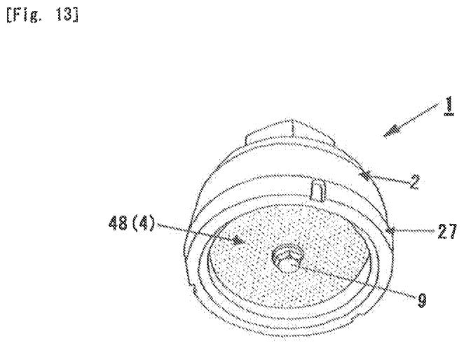

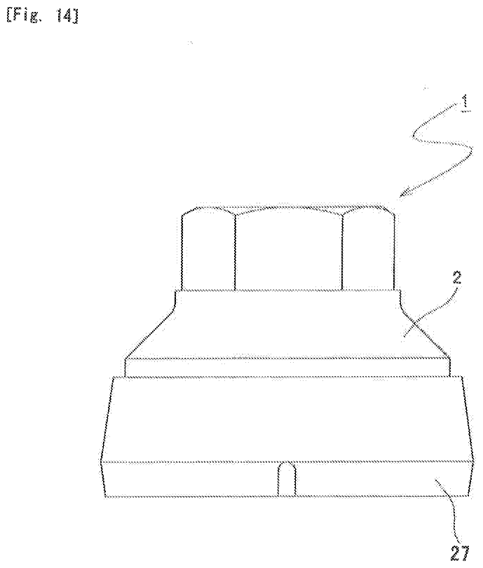

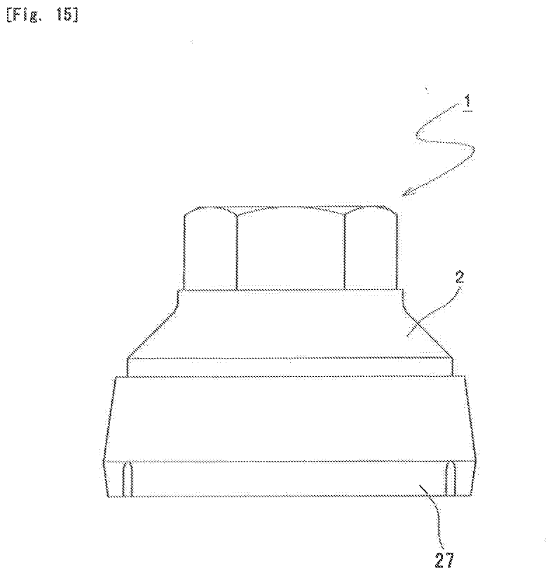

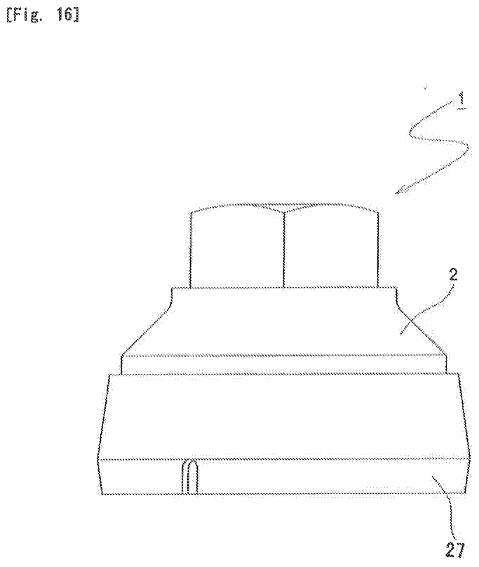

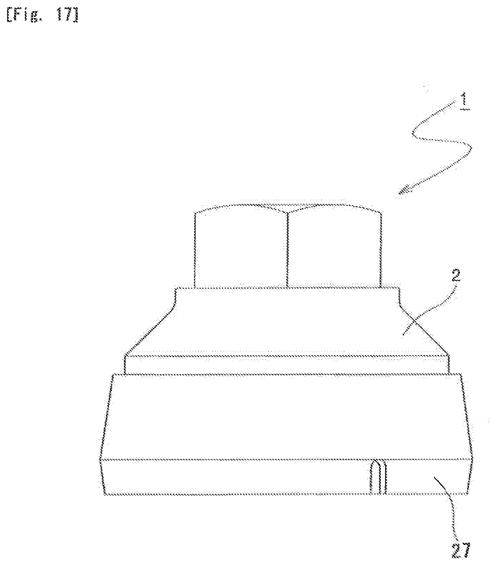

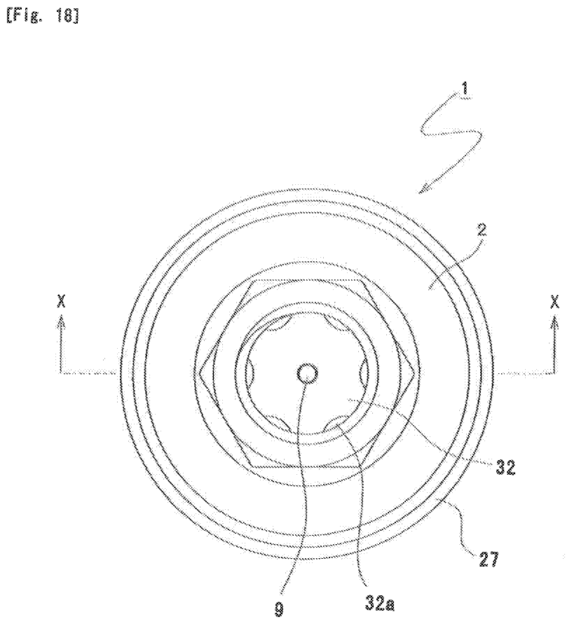

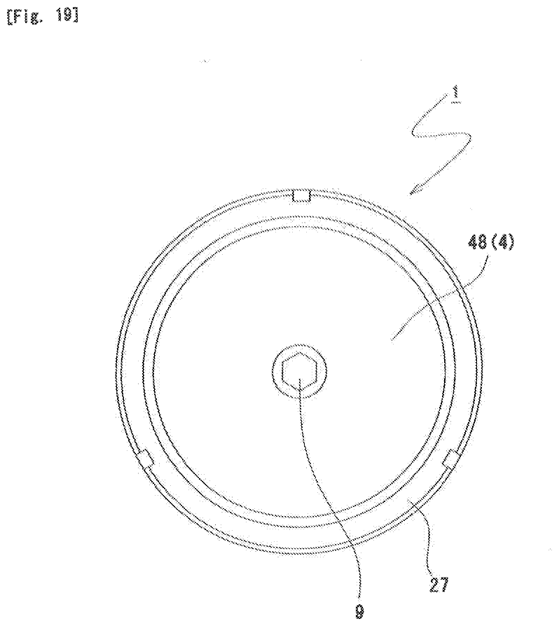

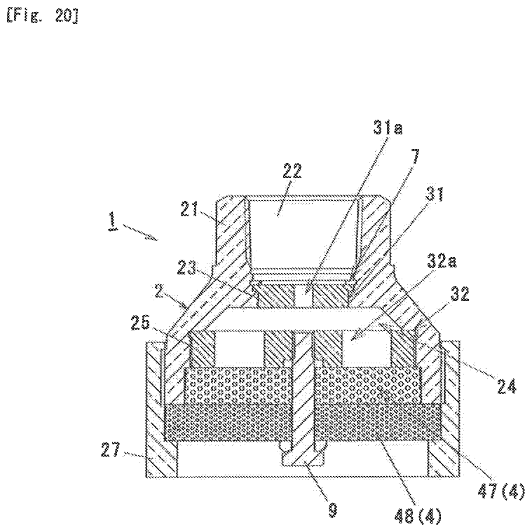

FIGS. 13 to 20 show an eighth embodiment of the injection head having the silencing function for gas-type fire extinguisher of the present invention.

In this injection head 1 having the silencing function for gas-type fire extinguisher, instead of performing to support the silencing member 4 of the injection head 1 of the first embodiment by the bolt 5 and the ring member 6, the ring member 27 abutting against the peripheral edge of one-side face released to the atmosphere of the silencing member 4 for supporting the silencing member 4 to the injection head main body 2, and screwing the injection head main body 2, and a bolt 9 abutting against the central part of one-side end face released to the atmosphere of the silencing member 4 for supporting the silencing member 4 to the injection head main body 2, and screwing the orifice plate 32 perform the support.

Here, the silencing member 4 is formed in split structures, composed of an upstream side member 47, and a downstream side member 48. The silencing member 4 is disposed with the end face of other side of the silencing member 4 (the opposite side of the side released to the atmosphere) in contact with the injection head main body 2 (in this embodiment, including the orifice plate 32), and the end face of one side of the silencing member 4 (the side released to the atmosphere) being supported on the injection head main body 2 by way of the ring member 27 contacting with the peripheral edge of this end face, and the bolts 9 contacting with the central parts of the end face. The downstream side member 48 composing the silencing member 4 formed in a larger diameter than the upstream side member 47, and the outer peripheral edge of this downstream side member 48 fixed as being held between the end face of the injection head main body 2 and the peripheral edge of the ring member 27, and therefore the emission area of the fire-extinguishing gas released to the atmosphere of the silencing member 4 (downstream side member 48) is further increased, and the noise reduction rate can be heightened at the same time.

Other structure and action of the injection head 1 of the eighth embodiment are the same as in the injection head 1 of the first embodiment.

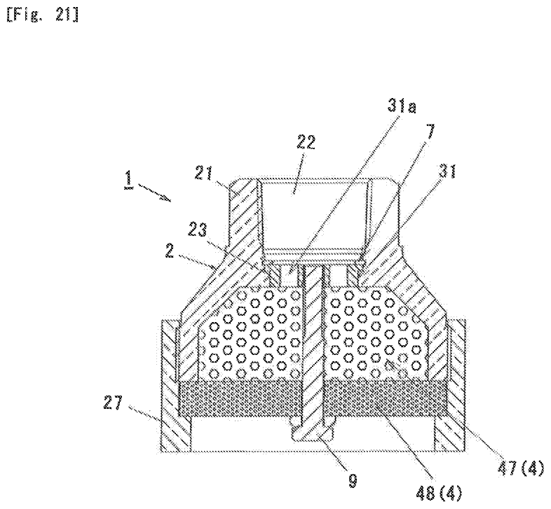

FIG. 21 shows a ninth embodiment of the injection head having the silencing function for gas-type fire extinguisher of the present invention.

In this injection head 1 having the silencing function for gas-type fire extinguisher, the orifice plate 32 of the injection head 1 of the eighth embodiment is omitted, and the silencing member 4 is disposed at the outlet side of the orifice plate 31 for releasing the fire-extinguishing gas (In other embodiments below, in the same way as the present embodiment, the orifice plate 32 can be omitted.).

In the injection head 1 of the eighth embodiment, at the outlet side of the orifice plate 31 for releasing the fire extinguishing gas, a layer-like space 24 can be provided.

Other structure and action of the injection head 1 of the ninth embodiment are the same as in the injection heads 1 of the first embodiment, and the eighth embodiment.

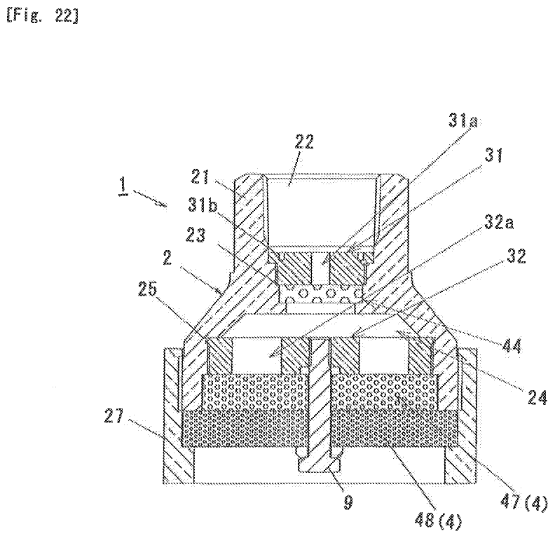

FIG. 22 shows a tenth embodiment of the injection head having the silencing function for gas-type fire extinguisher of the present invention.

In this injection head 1 having the silencing function for gas-type fire extinguisher, in the same way as the third embodiment, the orifice plate 31 of the injection head 1 of the eighth embodiment is fixed detachably by way of screws formed in the peripheral surface in the step 23 formed in the internal space in the side of the connecting part 21 of the injection head main body 2, and the orifice plate 32.

Here, at the outlet side of the orifice plate 31 for releasing the fire extinguishing gas, the silencing member 44 is disposed.

Other structure and action of the injection head 1 of the tenth embodiment are the same as in the injection heads 1 of the first embodiment, the third embodiment, and the eighth embodiment.

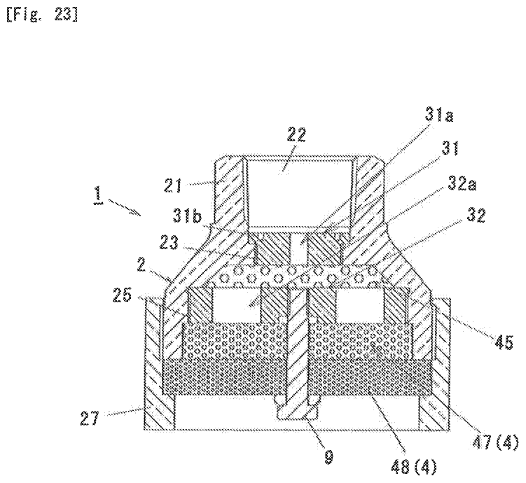

FIG. 23 shows an eleventh embodiment of the injection head having the silencing function for gas-type fire extinguisher of the present invention.

In this injection head 1 having the silencing function for gas-type fire extinguisher, in the same way as the injection head 1 of the third embodiment, the orifice plate 31 of the injection head 1 of the eighth embodiment is fixed detachably by way of screws formed in the peripheral surface in the step 23 and the orifice plate 32 formed in the internal space in the side the connecting part 21 of the injection head main body 2.

Also, the silencing member 45 is disposed at the place which was the space 24 in the injection head 1 of the first embodiment, and was continued from the outlet side of the orifice plate 31 for releasing the fire extinguishing gas.

Other structure and action of the injection head 1 of the eleventh embodiment are the same as in the injection heads 1 of the first embodiment, the third embodiment, and the eighth embodiment.

Herein, the injection head having the silencing function for gas-type fire extinguisher of the present invention is described by referring to a plurality of embodiments, but it must be noted that the present invention is not limited to the illustrated embodiments alone, but may be changed or modified in various forms within the true spirit thereof.

### INDUSTRIAL APPLICABILITY

The injection head having the silencing function for gas-type fire extinguisher of the present invention is easy to store as stock, and is capable of eliminating the problems of place of storage and the cost increase, and hence it can be used in wide applications of the gas-type fire extinguishers using fire-extinguishing gases such as nitrogen, carbon dioxide, fluorine compound and others, and it can be applied not only in new installations of gas-type fire extinguishers, but also in existing facilities of gas-type fire extinguishers only by exchanging the injection head.

### DESCRIPTION OF THE REFERENCE NUMERALS

1 injection head
2 injection head main body
21 connecting part
22 opening
23 step
24 space
25 step
26 deflector
27 ring member
31 orifice plate
31a orifice
31b operation part
32 orifice plate
32a orifice
33 orifice cylinder
33a orifice
4 silencing member
41 central member
42 peripheral member
43 end member
44 silencing member
45 silencing member
46 silencing member
47 upstream side member
48 downstream side member
5 bolt
6 ring member
7 C-type retaining ring
8 operation tool
9 bolt

1. An injection head having a silencing function for gas-type fire extinguisher, being an injection head having a silencing means installed by connecting a piping for providing a fire-extinguishing gas for releasing the fire-extinguishing gas in a fire-extinguishing area in the gas-type fire extinguisher using a fire-extinguishing gas, wherein said silencing means is composed of an injector head main body forming a connecting part connecting said piping, an orifice plate forming an orifice passing a fire extinguishing gas disposed in said injection head main body, and a silencing member of block shapes formed on porous material capable of passing a fire extinguishing gas disposed at the outlet side of the orifice plate for releasing a fire extinguishing gas, and
wherein said orifice plate is disposed detachable in said injector head main body through an opening of said connecting part connected to said piping of said injector head main body.

2. The injection head having a silencing function for gas-type fire extinguisher according to claim 1, wherein said orifice plate is fixed by a C-type retaining ring mounted on said connecting part side connected with said piping of said injection head main body.

3. The injection head having a silencing function for gas-type fire extinguisher according to claim 1, wherein said orifice plate is screwed into said said injection head main body, and said orifice plate is forming an operation part for rotating said orifice plate through an opening of said connecting part side connected to said piping of said injection head main body.

4. A method for storing and assembling an injection head having silencing function for gas-type fire extinguisher, being a method for storing and assembling an injection head having a silencing means installed by connecting a piping for providing a fire-extinguishing gas for releasing the fire-extinguishing gas in a fire-extinguishing area in the gas-type fire extinguisher using a fire-extinguishing gas according to claim 1,
wherein said injection head is composed of an injector head main body forming a connecting part connecting said piping, an orifice plate forming an orifice passing a fire extinguishing gas disposed in said injection head main body, and a silencing member of block shapes formed on porous material capable of passing a fire extinguishing gas disposed at the outlet side of the orifice plate for releasing a fire extinguishing gas,
wherein said orifice plate is disposed detachable in said injector head main body through an opening of said connecting part connected to said piping of said injector head main body, and
wherein said injection head is stored in a condition of which said silencing member assembled to said injection head main body, and when shipping, said orifice plate is attached to said injection head main body through said opening of said connecting part side of said piping of said injection head main body.
